(19) United States
(12) Patent Application Publication
(10) Pub. No.: US 2011/0186393 A1
(43) Pub. Date: Aug. 4, 2011

(54) SHOCK ABSORBER

(76) Inventors: Atsushi MAEDA, Fujisawa-shi (JP); Hiroyasu SATO, Yokohama-shi (JP)

(21) Appl. No.: 13/014,174

(22) Filed: Jan. 26, 2011

(30) Foreign Application Priority Data
Jan. 29, 2010 (JP) 19557/2010

(51) Int. Cl. F16F 9/34

(52) U.S. Cl. 188/280

(57) ABSTRACT

A piston connected to a piston rod is fitted in a cylinder having a hydraulic oil sealed therein. Flows of hydraulic oil induced in extension and compression passages by sliding movement of the piston are controlled by extension and compression damping force generating mechanisms, respectively, to generate damping force. In the extension and compression damping force generating mechanisms, the hydraulic oil is introduced into back pressure chambers through back pressure introducing orifices, respectively, and the opening of relief valves is controlled by the pressures in the back pressure chambers, respectively. In a low piston speed region, damping valves open, which are provided downstream of the back pressure chambers, respectively, and as the piston speed increases, the relief valves open to suppress an excessive increase of damping force. After the relief valves have opened as a result of an increase in the piston speed, the relief valves are kept open at piston speeds not lower than the piston speed at which the relief valves open, thereby obtaining stable damping force.

### BACKGROUND OF THE INVENTION

The present invention relates to shock absorbers such as hydraulic shock absorbers that generate a damping force by controlling the flow of a hydraulic fluid against the stroke of a piston rod.

Hydraulic shock absorbers attached to the suspension systems of vehicles, for example, are desired to have optimal damping force characteristics in order to improve ride quality and steering stability. In general, this type of hydraulic shock absorber has a piston connected to a piston rod and slidably fitted in a cylinder having a hydraulic fluid therein. The flow of hydraulic fluid induced by sliding movement of the piston in the cylinder caused by the stroke of the piston rod is controlled by a damping force generating mechanism, which comprises an orifice, a disk valve, etc., to generate a damping force, and the damping force characteristics are adjusted on the basis of the flow path area of the orifice, the valve opening characteristics of the disk valve and so forth.

A hydraulic shock absorber disclosed in Japanese Patent Application Publication No. 2006-10069 has a back pressure chamber and a relief valve at the back of the disk valve of the damping force generating mechanism. The relief valve relieves the pressure in the back pressure chamber to the downstream side. A part of the hydraulic fluid is introduced into the back pressure chamber, and the pressure in the back pressure chamber is applied to the disk valve in the direction for closing the disk valve, thereby adjusting the valve opening pressure of the disk valve, and thus increasing the degree of freedom for setting damping force characteristics.

### SUMMARY OF THE INVENTION

An object of the present invention is to provide a shock absorber further increased in the degree of freedom for setting damping force characteristics to obtain desired damping force characteristics.

To solve the above-described problem, the present invention provides a shock absorber including a cylinder having a hydraulic fluid sealed therein, a piston slidably fitted in the cylinder, a piston rod connected to the piston and extending to the outside of the cylinder, a relief valve controlling the flow of the hydraulic fluid from an upstream chamber toward a downstream chamber induced by sliding movement of the piston in one direction, a back pressure chamber applying the pressure therein to the relief valve in a direction for closing the relief valve, a back pressure introducing orifice introducing the hydraulic fluid from the upstream chamber into the back pressure chamber, a damping valve caused to open by the pressure in the back pressure chamber to generate a damping force by controlling the flow of hydraulic fluid toward the downstream chamber, and a downstream orifice communicating between the back pressure chamber and the downstream chamber. The back pressure introducing orifice has a flow path area that is constant or decreases according as the degree of opening of the relief valve increases.

The flow path area of the back pressure introducing orifice and that of the downstream orifice may be set so that, after the relief valve has opened as a result of an increase in a piston speed, the relief valve is kept open at piston speeds not lower than the piston speed at which the relief valve opens.

The flow path area of the back pressure introducing orifice may be set so that, after the damping valve has opened as a result of an increase in a piston speed, the relief valve is kept open at piston speeds not lower than the piston speed at which the damping valve opens by a pressure balance between an upstream side of the relief valve and the back pressure chamber.

The shock absorber may further comprise a check valve allowing only a flow of the hydraulic fluid through the back pressure introducing orifice toward the back pressure chamber.

The shock absorber may further comprise a back pressure check valve allowing a flow of the hydraulic fluid from the downstream chamber toward the back pressure chamber and introducing the hydraulic fluid into the back pressure chamber from the downstream chamber through a back pressure orifice when the piston slides in an other direction.

The flow path area of the back pressure introducing orifice may be larger than that of the downstream orifice but smaller than a sum total of the flow path areas of the downstream orifice and the back pressure orifice.

The flow path area of the back pressure introducing orifice may be larger than that of the downstream orifice but smaller than a sum total of the flow path areas of the downstream orifice and the back pressure orifice.

The shock absorber may further comprise an urging member urging the relief valve in the direction for closing the relief valve.

The shock absorber may further comprise a valve member attached to an end of the piston, the valve member having a guide portion extending along the piston rod;

an inner peripheral edge of the relief valve being movable along an outer peripheral surface of the guide portion of the valve member;

the back pressure introducing orifice being formed between the inner peripheral edge of the relief valve and the guide portion of the valve member.

The guide portion of the valve member may have a tapered portion formed on an outer peripheral surface of a distal end thereof that faces the inner peripheral edge of the relief valve, so that, when the relief valve opens, the flow path area of the back pressure introducing orifice decreases according as the degree of opening of the relief valve increases.

### BRIEF DESCRIPTION OF THE DRAWINGS

FIG. 1 is an enlarged vertical sectional view showing a main part of a shock absorber according to a first embodiment of the present invention.

FIG. 2 is a vertical sectional view of the shock absorber shown in FIG. 1.

FIG. 3 is an enlarged vertical sectional view of an extension damping force generating mechanism of the shock absorber shown in FIG. 1.

FIG. 4 is an enlarged vertical sectional view showing a main part of a shock absorber according to a second embodiment of the present invention.

FIG. 5 is a vertical sectional view showing an extension relief valve of the shock absorber in FIG. 4 when the valve is open.

FIG. 6 is an enlarged vertical sectional view showing a main part of a shock absorber according to a third embodiment of the present invention.

FIG. 7 is a graph showing damping force characteristics of the shock absorber according to the present invention.

### DETAILED DESCRIPTION OF THE INVENTION

Embodiments of the present invention will be explained below in detail with reference to the accompanying drawings.

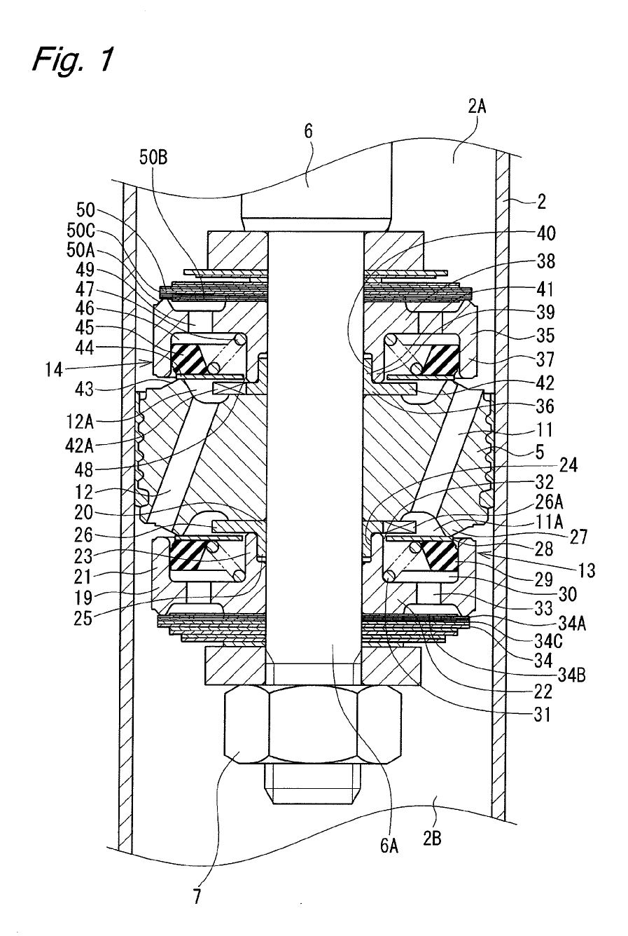

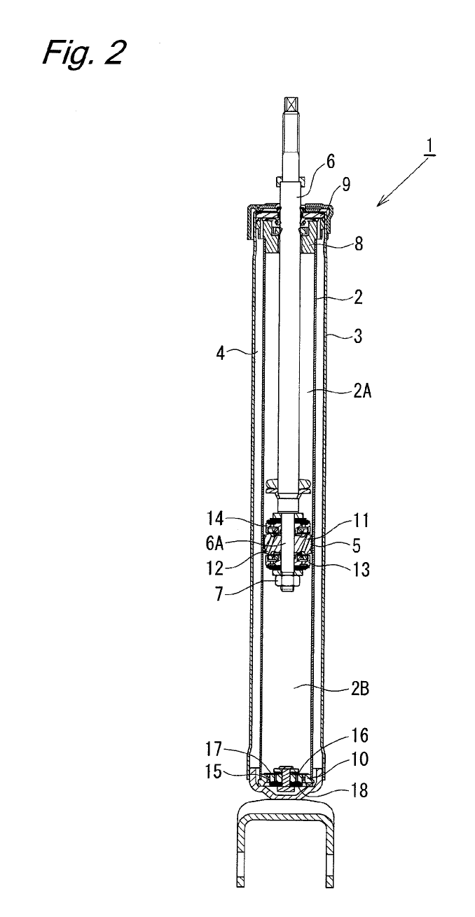

A first embodiment of the present invention will be explained with reference to FIGS. 1 to 3. As shown in FIGS. 1 and 2, a shock absorber 1 according to this embodiment is a dual-tube shock absorber having a double-tube structure comprising a cylinder 2 and an outer tube 3 provided around the outer periphery of the cylinder 2. An annular reservoir 4 is formed between the cylinder 2 and the outer tube 3. A piston 5 is slidably fitted in the cylinder 2. The piston 5 divides the interior of the cylinder 2 into two chambers, i.e. a cylinder upper chamber 2A and a cylinder lower chamber 2B. The piston 5 is connected to a small-diameter portion 6A at one end of a piston rod 6 by a nut 7. The other end portion of the piston rod 6 extends slidably and fluid-tightly through a rod guide 8 and an oil seal 9, which are provided in the upper end portion of the double-tube structure comprising the cylinder 2 and the outer tube 3, and projects to the outside of the cylinder 2. A base valve 10 is provided in the lower end portion of the cylinder 2 to divide the cylinder lower chamber 2B and the reservoir 4 from each other. A hydraulic oil is sealed in the cylinder 2 as a hydraulic fluid, and the hydraulic oil and a gas are sealed in the reservoir 4.

The piston 5 is provided with an extension passage 11 and a compression passage 12 for communication between the cylinder upper and lower chambers 2A and 2B. The piston 5 is further provided with an extension damping force generating mechanism 13 generating a damping force by controlling the flow of hydraulic oil from the cylinder upper chamber 2A toward the cylinder lower chamber 2B during the extension stroke of the piston rod 6, during which the cylinder upper chamber 2A serves as an upstream chamber of the extension passage 11 and the cylinder lower chamber 2B as a downstream chamber of the extension passage 11. Further, the piston 5 is provided with a compression damping force generating mechanism 14 generating a damping force by controlling the flow of hydraulic oil from the cylinder lower chamber 2B toward the cylinder upper chamber 2A during the compression stroke of the piston rod 6, during which the cylinder lower chamber 2B serves as an upstream chamber of the compression passage 12 and the cylinder upper chamber 2A as a downstream chamber of the compression passage 12.

The base valve 10 is provided with an extension passage 15 and a compression passage 16 for communication between the cylinder lower chamber 2B and the reservoir 4. The extension passage 15 is provided with a check valve 17 allowing only the flow of hydraulic oil from the reservoir 4 toward the cylinder lower chamber 2B. The compression passage 16 is provided with a compression disk valve 18 generating a damping force by controlling the flow of hydraulic oil from the cylinder lower chamber 2B toward the reservoir 4.

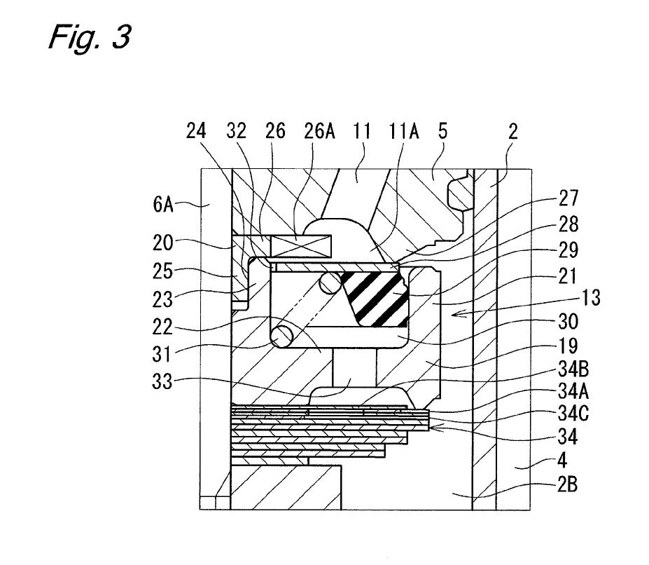

The compression damping force generating mechanism 14 will be explained with reference also to FIG. 3. A valve member 19 is attached through a retaining member 20 to a portion of the piston 5 at an end thereof closer to the cylinder lower chamber 2B. The valve member 19 is in the shape of a circular cylinder, one end of which is closed. That is, the valve member 19 has a circular cylindrical portion 21 and a bottom portion 22. The bottom portion 22 has a circular cylindrical guide portion 23 standing on the inner side thereof. The guide portion 23 is concentric with and smaller in diameter than the cylindrical portion 21. The guide portion 23 has an enlarged-diameter portion 24 on the inner periphery of the distal end thereof. The retaining member 20 has a circular cylindrical portion 25 and an outer flange portion 26 provided on one end of the cylindrical portion 25. The retaining member 20 has a convex shape. The cylindrical portion 25 fits in the enlarged-diameter portion 24 of the guide portion 23 of the valve member 19. The outer flange portion 26 abuts against both the distal end of the guide portion 23 and the end surface of the piston 5. During assembly, the small-diameter portion 6A of the piston rod 6 is inserted into the guide portion 23 and the cylindrical portion 25, and the nut 7 is screwed onto the distal end of the small-diameter portion 6A and tightened to thereby secure the valve member 19 and the retaining member 20 to the piston 5. The outer peripheral portion of the outer flange portion 26 of the retaining member 20 is provided with one or a plurality of circumferentially spaced cut portions 26A.

The piston 5 has an annular seat portion 27 projecting from the outer periphery of an end surface thereof closer to the cylinder lower chamber 2B. The projection height of the seat portion 27 is greater than the thickness of the outer flange portion 26 of the retaining member 20 secured to the piston 5, and the seat portion 27 projects closer to a relief valve 28 than the outer flange portion 26. The extension passage 11 opens at the inner peripheral side of the seat portion 27. The outer peripheral portion of the relief valve 28 seats on the seat portion 27. The relief valve 28 is an annular disk valve. An annular elastic seal member 29 is fixed to the outer peripheral portion of the back of the relief valve 28. The outer peripheral portion of the elastic seal member 29 slidably and liquid-tightly abuts against the inner peripheral surface of the cylindrical portion 21 of the valve member 19 to form a back pressure chamber 30 inside the valve member 19. A valve spring 31 as an urging member made of a tapered compression coil spring is interposed between the relief valve 28 and the bottom portion 22 of the valve member 19. The valve spring 31 urges the relief valve 28 in the valve closing direction by the spring force thereof to seat the relief valve 28 on the seat portion 27.

An annular gap is formed between the inner peripheral edge of the relief valve 28 and the guide portion 23 of the valve member 19. The gap forms a back pressure introducing orifice 32 having an always constant flow path area and constantly connecting together the back pressure chamber 30 and a port chamber 11A (communicating with the extension passage 11) at the inner peripheral side of the seat portion 27. The term “an always constant flow path area”, as used herein, means that the flow path area of the back pressure introducing orifice 32 is constant regardless of whether the relief valve 28 seats on or unseats from the seat portion 27. Upon receiving the pressure in the port chamber 11A communicating with the extension passage 11, the relief valve 28 moves toward the bottom portion 22 of the valve member 19 to unseat from the seat portion 27. Consequently, the relief valve 28 opens, substantially without being deflected, to allow the port chamber 11A to communicate directly with the cylinder lower chamber 28. At this time, the pressure in the back pressure chamber 30 acts on the relief valve 28 in the valve closing direction. In addition, the inner peripheral edge of the relief valve 28 moves along the outer peripheral surface of the circular cylindrical guide portion 23, whereby the flow path area of the back pressure introducing orifice 32 is kept constant.

The bottom portion 22 of the valve member 19 is provided with a passage 33 for communication between the back pressure chamber 30 and the cylinder lower chamber 2B. The outer side of the bottom portion 22 is provided with a damping valve 34 selectively opening and closing the passage 33. The damping valve 34 is a normally-closed disk valve that is opened by the pressure in the back pressure chamber 30 to adjust the flow path area between the back pressure chamber 30 and the cylinder lower chamber 2B according to the degree of opening thereof. The damping valve 34 is provided with a downstream orifice 34A constantly communicating between the back pressure chamber 30 and the cylinder lower chamber 2B. The damping valve 34 is further provided with a back pressure check valve 34B allowing only the flow of hydraulic oil from the cylinder lower chamber 2B toward the back pressure chamber 30. The flow path area of the back pressure check valve 34B is restricted to a fixed flow path area by a back pressure orifice 34C. The damping valve 34 comprises a plurality of stacked disks. The downstream orifice 34A, the back pressure check valve 34B and the back pressure orifice 34C are formed by providing cut portions to be passages in the disks constituting the damping valve 34.

The flow path area of each orifice provided in the extension damping force generating mechanism 13 is set to satisfy the following relationships.

(1) (The Condition for the Lower Limit of the Flow Path Area of the Back Pressure Introducing Orifice 32)

The flow path area of the back pressure introducing orifice 32 is set larger than the flow path area of the damping valve 34 when it is open, so that the relief valve 28 is kept closed immediately after the damping valve 34 has opened as a result of an increase in the piston speed.

(2) (The Condition for the Upper Limit of the Flow Path Area of the Back Pressure Introducing Orifice 32)

The flow path area of the back pressure introducing orifice 32 is set so that, when the piston speed further increases in excess of the speed in (1), the relief valve 28 opens, and that, at piston speeds not lower than the piston speed at which the relief valve 28 opens, the relief valve 28 is kept open by the pressure balance between the port chamber 11A, which is upstream of the relief valve 28, and the back pressure chamber 30. That is, the flow path area of the back pressure introducing orifice 32 is set so that the pressure in the back pressure chamber 30 will not become excessively high.

(3) The Flow Path Area of the Back Pressure Introducing Orifice 32 is Set Larger than the Flow Path Area of the Downstream Orifice 34A but Smaller than the Sum Total of the Flow Path Areas of the Downstream Orifice 34A and the Back Pressure Orifice 34C.

Next, the compression damping force generating mechanism 14 will be explained with reference mainly to FIG. 1.

The structure of the compression damping force generating mechanism 14 is similar to that of the above-described extension damping force generating mechanism 13. That is, a valve member 35 is attached through a retaining member 36 to a portion of the piston 5 at an end thereof closer to the cylinder upper chamber 2A. The valve member 35 is in the shape of a circular cylinder, one end of which is closed. That is, the valve member 35 has a circular cylindrical portion 37 and a bottom portion 38. The bottom portion 38 has a guide portion 39 standing thereon. The guide portion 39 has an enlarged-diameter portion 40 on the inner periphery of the distal end thereof. The retaining member 36 has a circular cylindrical portion 41 and an outer flange portion 42 provided on one end of the cylindrical portion 41. The retaining member 36 has a convex shape. The cylindrical portion 41 fits in the enlarged-diameter portion 40 of the guide portion 39 of the valve member 35. The outer flange portion 42 abuts against both the distal end of the guide portion 39 and the end surface of the piston 5. During assembly, the small-diameter portion 6A of the piston rod 6 is inserted into the guide portion 39 and the cylindrical portion 41, and the nut 7 is tightened to thereby secure the valve member 35 and the retaining member 36 to the piston 5. The outer peripheral portion of the outer flange portion 42 of the retaining member 36 is provided with one or a plurality of circumferentially spaced cut portions 42A.

The piston 5 has an annular seat portion 43 projecting from the outer periphery of an end surface thereof closer to the cylinder upper chamber 2A. The projection height of the seat portion 43 is greater than the thickness of the outer flange portion 42 of the retaining member 36 secured to the piston 5, and the seat portion 43 projects closer to a relief valve 44 than the outer flange portion 42. The compression passage 12 opens at the inner peripheral side of the seat portion 43. The outer peripheral portion of the relief valve 44, which is an annular disk valve, seats on the seat portion 43. An annular elastic seal member 45 is fixed to the outer peripheral portion of the back of the relief valve 44. The outer peripheral portion of the elastic seal member 45 slidably and liquid-tightly abuts against the inner peripheral surface of the cylindrical portion 37 of the valve member 35 to form a back pressure chamber 46 inside the valve member 35. A valve spring 47 as an urging member made of a tapered compression coil spring is interposed between the relief valve 44 and the bottom portion 38 of the valve member 35. The valve spring 47 urges the relief valve 44 in the valve closing direction by the spring force thereof to seat the relief valve 44 on the seat portion 43.

An annular gap is formed between the inner peripheral edge of the relief valve 44 and the guide portion 39 of the valve member 35. The gap forms a back pressure introducing orifice 48 having an always constant flow path area and constantly connecting together the back pressure chamber 46 and a port chamber 12A (communicating with the compression passage 12) at the inner peripheral side of the seat portion 43. The term “an always constant flow path area”, as used herein, means that the flow path area of the back pressure introducing orifice 48 is constant regardless of whether the relief valve 44 seats on or unseats from the seat portion 43. Upon receiving the pressure in the port chamber 12A communicating with the compression passage 12, the relief valve 44 moves toward the bottom portion 38 of the valve member 35 to unseat from the seat portion 43. Consequently, the relief valve 44 opens, without being deflected, to allow the port chamber 12A to communicate with the cylinder upper chamber 2A. At this time, the pressure in the back pressure chamber 46 acts on the relief valve 44 in the valve closing direction. In addition, the inner peripheral edge of the relief valve 44 moves along the outer peripheral surface of the circular cylindrical guide portion 39, whereby the flow path area of the back pressure introducing orifice 48 is kept constant.

The bottom portion 38 of the valve member 35 is provided with a passage 49 for communication between the back pressure chamber 46 and the cylinder upper chamber 2A. The outer side of the bottom portion 38 is provided with a damping valve 50 selectively opening and closing the passage 49. The damping valve 50 is a normally-closed disk valve that is opened by the pressure in the back pressure chamber 46 to adjust the flow path area between the back pressure chamber 46 and the cylinder upper chamber 2A according to the degree of opening thereof. The damping valve 50 is provided with a downstream orifice 50A constantly communicating between the back pressure chamber 46 and the cylinder upper chamber 2A. The damping valve 50 is further provided with a back pressure check valve 50B allowing only the flow of hydraulic oil from the cylinder upper chamber 2A toward the back pressure chamber 46. The flow path area of the back pressure check valve 50B is restricted to a fixed flow path area by a back pressure orifice 50C. The damping valve 50 comprises a plurality of stacked disks. The downstream orifice 50A, the back pressure check valve 50B and the back pressure orifice 50C are formed by providing cut portions to be passages in the disks constituting the damping valve 50.

The flow path area of each orifice provided in the compression damping force generating mechanism 14 is set to satisfy the following relationships.

(1) (The Condition for the Lower Limit of the Flow Path Area of the Back Pressure Introducing Orifice 48)

The flow path area of the back pressure introducing orifice 48 is set larger than the flow path area of the damping valve 50 when it is open, so that the relief valve 44 is kept closed immediately after the damping valve 50 has opened as a result of an increase in the piston speed.

(2) (The Condition for the Upper Limit of the Flow Path Area of the Back Pressure Introducing Orifice 48)

The flow path area of the back pressure introducing orifice 48 is set so that, when the piston speed further increases in excess of the speed in (1), the relief valve 44 opens, and that, at piston speeds not lower than the piston speed at which the relief valve 44 opens, the relief valve 44 is kept open by the pressure balance between the port chamber 12A, which is upstream of the relief valve 44, and the back pressure chamber 46. That is, the flow path area of the back pressure introducing orifice 48 is set so that the pressure in the back pressure chamber 46 will not become excessively high.

(3) The Flow Path Area of the Back Pressure Introducing Orifice 48 is Set Larger than the Flow Path Area of the Downstream Orifice 50A but Smaller than the Sum Total of the Flow Path Areas of the Downstream Orifice 50A and the Back Pressure Orifice 50C.

The following is an explanation of the operation of this embodiment arranged as stated above.

During the extension stroke of the piston rod 6, the sliding movement of the piston 5 in the cylinder 2 causes the hydraulic oil in the cylinder upper chamber 2A to be pressurized, and the pressurized hydraulic oil flows toward the cylinder lower chamber 2B through the extension passage 11 of the piston 5. Thus, a damping force is generated mainly by the extension damping force generating mechanism 13. At this time, an amount of hydraulic oil corresponding to the amount by which the piston rod 6 withdraws from the cylinder 2 flows into the cylinder lower chamber 2B from the reservoir 4 by opening the check valve 17 for the extension passage 15 of the base valve 10, and the gas in the reservoir 4 expands correspondingly, thereby compensating for a volumetric change of the hydraulic oil in the cylinder 2.

In the extension damping force generating mechanism 13, the hydraulic oil flows as follows. Before the relief valve 28 opens, the hydraulic oil flows from the extension passage 11, i.e. the port chamber 11A, toward the cylinder lower chamber 2B through the back pressure introducing orifice 32, the back pressure chamber 30, the passage 33 and the damping valve 34. When the relief valve 28 is open, the hydraulic oil flows from the port chamber 11A directly into the cylinder lower chamber 2B.

During the extension stroke, when the piston speed is in a very low speed region, neither the relief valve 28 nor the damping valve 34 opens, and the downstream orifice 34A generates a damping force of orifice characteristics (the damping force is approximately proportional to the square of the piston speed).

When the piston speed increases to reach a low speed region, the pressure in the back pressure chamber 30 increases owing to the difference in flow path area between the back pressure introducing orifice 32 and the downstream orifice 34A, causing the damping valve 34 to open. Consequently, a damping force having the valve characteristics of the damping valve 34 is generated (the damping force is approximately proportional to the piston speed), and the slope of the damping force characteristic curve becomes gentle. At this time, the opening of the damping valve 34 causes a temporary reduction in pressure in the back pressure chamber 30, but the relief valve 28 remains closed because the flow path area of the back pressure introducing orifice 32 is sufficiently large to keep the pressure in the back pressure chamber 30 higher than the pressure in the cylinder lower chamber 2B at the downstream side.

Thereafter, as the piston speed increases, the pressure in the back pressure chamber 30 increases again owing to the difference in flow path area between the back pressure introducing orifice 32 and the damping valve 34. Accordingly, the relief valve 28 is kept closed by the pressure in the back pressure chamber 30 until the piston speed reaches an intermediate speed region.

When the piston speed further increases to reach a high speed region, the differential pressure between the port chamber 11A and the back pressure chamber 30 reaches the valve opening pressure of the relief valve 28 owing to the restriction by the back pressure introducing orifice 32, and the relief valve 28 unseats from the seat portion 27 to open against the spring force of the valve spring 31. The opening of the relief valve 28 generates a damping force having the valve characteristics of the relief valve 28. Consequently, the slope of the damping force characteristic curve is made even gentler to suppress an excessive increase of damping force in the high piston speed region. After the relief valve 28 has opened, the hydraulic oil in the port chamber 11A flows out through two different paths. That is, one part of the hydraulic oil flows directly into the cylinder lower chamber 2B, and another part of the hydraulic oil flows into the back pressure chamber 30 through the back pressure introducing orifice 32. The degree of opening of the relief valve 28 is determined by the pressure balance between the port chamber 11A and the back pressure chamber 30. Thus, the relief valve 28 is kept open without being suddenly closed by an increase in pressure in the back pressure chamber 30. Therefore, a stable damping force of valve characteristics can be obtained.

During the compression stroke of the piston rod 6, the sliding movement of the piston 5 in the cylinder 2 causes the hydraulic oil in the cylinder lower chamber 2B to be pressurized, and the pressurized hydraulic oil flows toward the cylinder upper chamber 2A through the compression passage 12 of the piston 5. Thus, a damping force is generated mainly by the compression damping force generating mechanism 14. At this time, an amount of hydraulic oil corresponding to the amount by which the piston rod 6 enters the cylinder 2 flows into the reservoir 4 by opening the disk valve 18 for the compression passage 16 of the base valve 10 and compresses the gas in the reservoir 4, thereby compensating for a volumetric change of the hydraulic oil in the cylinder 2.

In the compression damping force generating mechanism 14, the hydraulic oil flows as follows. Before the relief valve 44 opens, the hydraulic oil flows from the compression passage 12, i.e. the port chamber 12A, toward the cylinder upper chamber 2A through the back pressure introducing orifice 48, the back pressure chamber 46, the passage 49 and the damping valve 50. When the relief valve 44 is open, the hydraulic oil flows from the port chamber 12A directly into the cylinder upper chamber 2A.

During the compression stroke, when the piston speed is in a very low speed region, neither the relief valve 44 nor the damping valve 50 opens, and the downstream orifice 50A generates a damping force of orifice characteristics (the damping force is approximately proportional to the square of the piston speed), as in the case of the above-described extension damping force generating mechanism 13.

When the piston speed increases to reach a low speed region, the pressure in the back pressure chamber 46 increases owing to the difference in flow path area between the back pressure introducing orifice 48 and the downstream orifice 50A, causing the damping valve 50 to open. Consequently, a damping force having the valve characteristics of the damping valve 50 is generated (the damping force is approximately proportional to the piston speed), and the slope of the damping force characteristic curve becomes gentle. At this time, the opening of the damping valve 50 causes a temporary reduction in pressure in the back pressure chamber 46, but the relief valve 44 remains closed because the flow path area of the back pressure introducing orifice 48 is sufficiently large to keep the pressure in the back pressure chamber 46 higher than the pressure in the cylinder upper chamber 2A at the downstream side.

Thereafter, as the piston speed increases, the pressure in the back pressure chamber 46 increases again owing to the difference in flow path area between the back pressure introducing orifice 48 and the damping valve 50. Accordingly, the relief valve 44 is kept closed by the pressure in the back pressure chamber 46 until the piston speed reaches an intermediate speed region.

When the piston speed further increases to reach a high speed region, the differential pressure between the port chamber 12A and the back pressure chamber 46 reaches the valve opening pressure of the relief valve 44 owing to the restriction by the back pressure introducing orifice 48, and the relief valve 44 unseats from the seat portion 43 to open against the spring force of the valve spring 47. The opening of the relief valve 44 generates a damping force having the valve characteristics of the relief valve 44. Consequently, the slope of the damping force characteristic curve is made even gentler to suppress an excessive increase of damping force in the high piston speed region. After the relief valve 44 has opened, the hydraulic oil in the port chamber 12A flows out through two different paths. That is, one part of the hydraulic oil flows directly into the cylinder upper chamber 2A, and another part of the hydraulic oil flows into the back pressure chamber 46 through the back pressure introducing orifice 48. The degree of opening of the relief valve 44 is determined by the pressure balance between the port chamber 12A and the back pressure chamber 46. Thus, the relief valve 44 is kept open without being suddenly closed by an increase in pressure in the back pressure chamber 46. Therefore, a stable damping force of valve characteristics can be obtained.

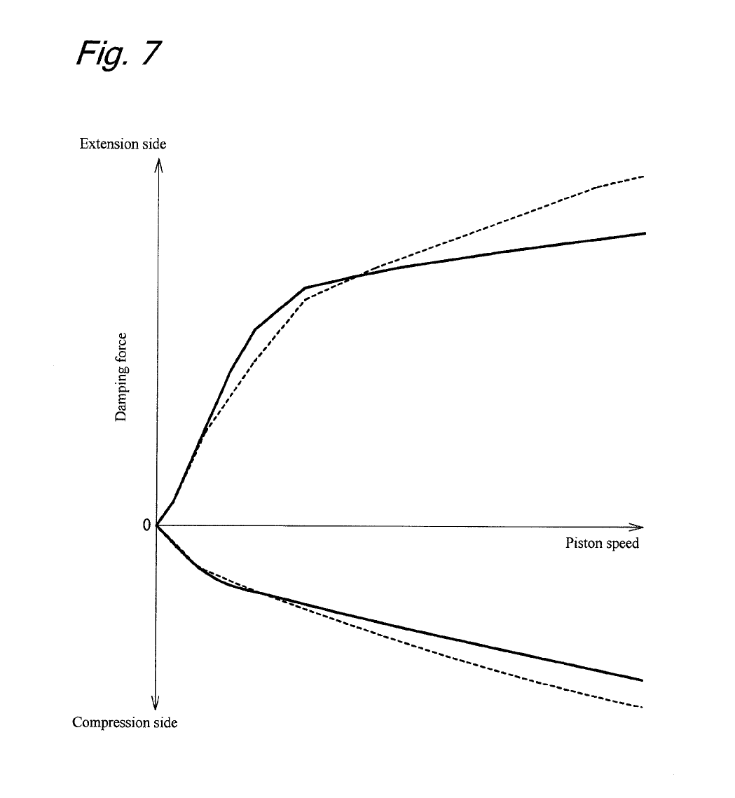

By suppressing a sharp pressure change in the back pressure chamber 30 (46) due to the opening of the damping valve 34 (50) as stated above, the damping valve 34 (50) and the relief valve 28 (44) are allowed to open successively at a predetermined timing, but not at the same time, as the piston speed increases. Thus, desired damping force characteristics can be obtained over the entire piston speed range from the very low speed region to the high speed region. As a result, the shock absorber 1 exhibits damping force characteristics as shown by the solid lines in FIG. 7. That is, in the low and intermediate piston speed regions, the damping force characteristic curve rises sharply to provide the required damping force. In the high piston speed region, the slope of the damping force characteristic curve is made gentle to suppress an excessive increase of damping force, thereby obtaining damping force characteristics suitable for improving the vehicle steering stability and ride quality. It should be noted that the broken lines in FIG. 7 show damping force characteristics of a conventional hydraulic shock absorber having a back pressure chamber arranged as disclosed in Japanese Patent Application Publication No. 2006-10069.

The following is an explanation of the operation of the compression damping force generating mechanism 14 during the extension stroke and the operation of the extension damping force generating mechanism 13 during the compression stroke.

During the extension stroke of the piston rod 6, in the compression damping force generating mechanism 14, the back pressure check valve 50B of the damping valve 50 opens to introduce the pressure in the cylinder upper chamber 2A into the back pressure chamber 46 through the back pressure orifice 50C. Consequently, the back pressure chamber 46 can be maintained in a pressurized state to prevent the relief valve 44 from opening and to allow the pressure in the back pressure chamber 46 to be increased rapidly when the piston rod stroke changes to the compression stroke, thereby enabling stable damping force to be generated.

During the compression stroke of the piston rod 6, in the extension damping force generating mechanism 13, the back pressure check valve 34B of the damping valve 34 opens to introduce the pressure in the cylinder lower chamber 2B into the back pressure chamber 30 through the back pressure orifice 34C. Thus, the back pressure chamber 30 can be maintained in a pressurized state. Consequently, the relief valve 28 can be prevented from opening, and the pressure in the back pressure chamber 30 can be increased rapidly when the piston rod stroke changes to the extension stroke. Thus, stable damping force can be generated.

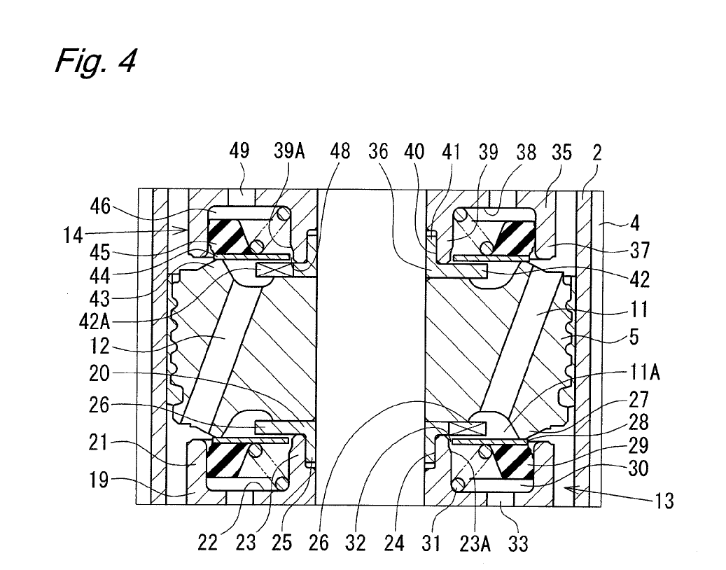

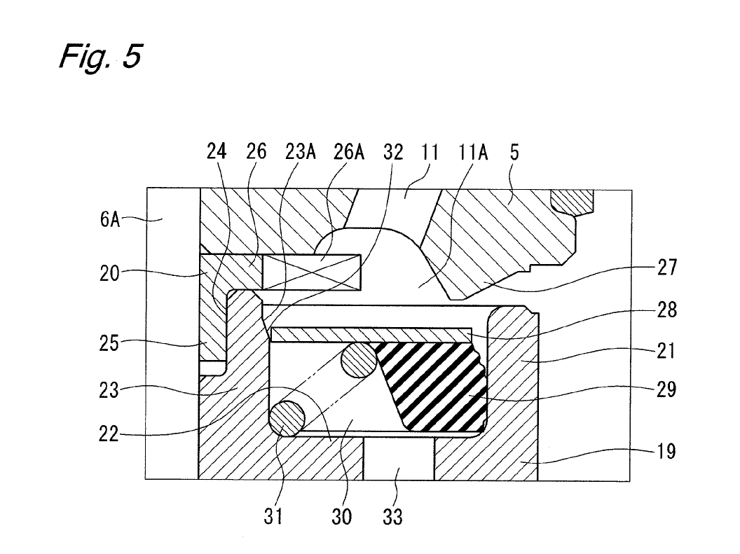

Next, a second embodiment of the present invention will be explained with reference mainly to FIGS. 4 and 5. In the following explanation, only a main part of the second embodiment will be illustrated. Members or portions of the second embodiment similar to those in the foregoing first embodiment are denoted by the same reference numerals as used in the first embodiment, and only the points in which the second embodiment differs from the first embodiment will be explained in detail.

As shown in FIGS. 4 and 5, the extension and compression damping force generating mechanisms 13 and 14 in the second embodiment are arranged as follows. The guide portion 23 (39) of the valve member 19 (35) has a tapered portion 23A (39A) on the outer peripheral surface of the distal end thereof that faces the inner peripheral edge of the relief valve 28 (44). Thus, when the relief valve 28 (44) opens, the flow path area of the back pressure introducing orifice 32 (48) decreases according as the degree of opening of the relief valve 28 (44) increases. FIG. 5 shows the extension damping force generating mechanism 13 when the relief valve 28 is fully open.

With the above-described structure, the second embodiment has the following advantage over the foregoing first embodiment, in which the back pressure introducing orifices 32 and 48 each have a fixed flow path area. In the second embodiment, although the valve opening pressure of the relief valve 28 (44), i.e. the piston speed at which the relief valve 28 (44) opens, is the same as in the first embodiment, after the relief valve 28 (44) has opened, the flow path area of the back pressure introducing orifice 32 (48) decreases according as the degree of opening of the relief valve 28 (44) increases. Consequently, the pressure in the back pressure chamber 30 (46) reduces, and it becomes easy for the relief valve 28 (44) to open. Accordingly, the slope of the damping force characteristic curve can be made even gentler.

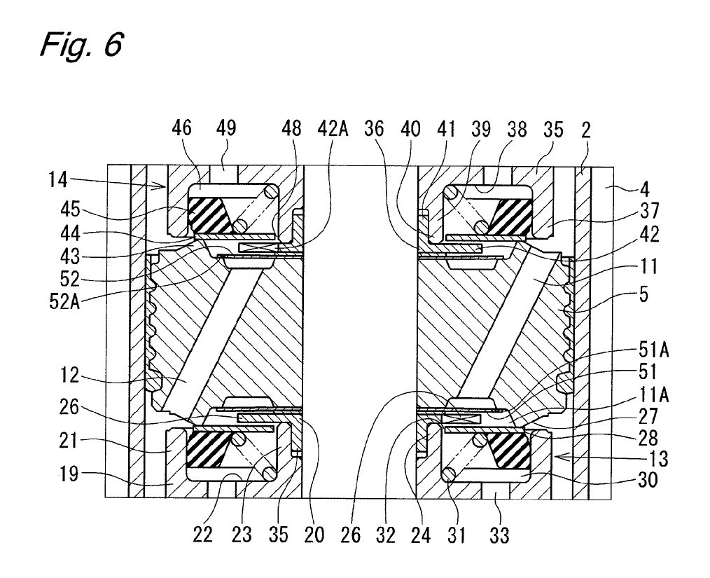

Next, a third embodiment of the present invention will be explained with reference mainly to FIG. 6. In the following explanation, only a main part of the third embodiment will be illustrated. Members or portions of the third embodiment similar to those in the foregoing first embodiment are denoted by the same reference numerals as used in the first embodiment, and only the points in which the third embodiment differs from the first embodiment will be explained in detail.

As shown in FIG. 6, in the third embodiment, a check valve 51 is provided at an opening to the port chamber 11A of the extension passage 11 of the extension damping force generating mechanism 13. The check valve 51 is a disk valve clamped at an inner peripheral portion thereof between the piston 5 and the retaining member 20. The check valve 51 opens by deflecting at the outer peripheral portion thereof, thereby allowing only the flow of hydraulic oil from the cylinder upper chamber 2A to the port chamber 11A through the extension passage 11. Thus, the check valve 51 allows only the flow of hydraulic oil toward the back pressure chamber 30 through the back pressure introducing orifice 32. Further, the check valve 51 is provided with an orifice 51A constantly allowing the flow of hydraulic oil through the extension passage 11. The flow path area of the orifice 51A is sufficiently smaller than that of the back pressure introducing orifice 32.

Similarly, a check valve 52 is provided at an opening to the port chamber 12A of the compression passage 12 of the compression damping force generating mechanism 14. The check valve 52 is a disk valve clamped at an inner peripheral portion thereof between the piston 5 and the retaining member 36. The check valve 52 opens by deflecting at the outer peripheral portion thereof, thereby allowing only the flow of hydraulic oil from the cylinder lower chamber 2B to the port chamber 12A through the compression passage 12. Thus, the check valve 52 allows only the flow of hydraulic oil toward the back pressure chamber 46 through the back pressure introducing orifice 48. Further, the check valve 52 is provided with an orifice 52A constantly allowing the flow of hydraulic oil through the compression passage 12. The flow path area of the orifice 52A is sufficiently smaller than that of the back pressure introducing orifice 48.

With the above-described structure, during the extension stroke of the piston rod 6, when the piston speed is in the very low speed region, the hydraulic oil flowing through the extension passage 11 passes through the orifice 51A of the check valve 51 to flow into the port chamber 11A. When the piston speed increases, the hydraulic oil flowing through the extension passage 11 opens the check valve 51 to flow into the port chamber 11A. During the compression stroke of the piston rod 6, when the piston speed is in the very low speed region, the hydraulic oil flowing through the compression passage 12 passes through the orifice 52A of the check valve 52 to flow into the port chamber 12A. When the piston speed increases, the hydraulic oil flowing through the compression passage 12 opens the check valve 52 to flow into the port chamber 12A.

During the extension stroke of the piston rod 6, in the compression damping force generating mechanism 14, the back pressure check valve 50B of the damping valve 50 opens to introduce the pressure in the cylinder upper chamber 2A into the back pressure chamber 46 through the back pressure orifice 50C, thereby maintaining the back pressure chamber 46 in a pressurized state, as in the case of the foregoing first embodiment. In this regard, if the flow path area of the back pressure introducing orifice 48 is large, the pressure in the back pressure chamber 46 is relieved toward the cylinder lower chamber 2B at the downstream side through the back pressure introducing orifice 48, thus preventing the pressure in the back pressure chamber 46 from readily increasing, and causing the damping force to reduce. In the third embodiment, however, the check valve 52 can suppress the hydraulic oil from being relieved from the back pressure chamber 46 toward the cylinder lower chamber 2B through the back pressure introducing orifice 48. Therefore, stable damping force can be obtained, and the flow path area of the back pressure introducing orifice 48 can be set sufficiently large.

During the compression stroke of the piston rod 6, in the extension damping force generating mechanism 13, the back pressure check valve 34B of the damping valve 34 opens to introduce the pressure in the cylinder lower chamber 2B into the back pressure chamber 30 through the back pressure orifice 34C, thereby maintaining the back pressure chamber 30 in a pressurized state. In this regard, if the flow path area of the back pressure introducing orifice 32 is large, the pressure in the back pressure chamber 30 is relieved toward the cylinder upper chamber 2A at the downstream side through the back pressure introducing orifice 32. Consequently, the pressure in the back pressure chamber 46 is prevented from readily increasing, and the damping force reduces. In the third embodiment, however, the check valve 51 can suppress the hydraulic oil from being relieved from the back pressure chamber 30 toward the cylinder upper chamber 2A through the back pressure introducing orifice 32. Therefore, stable damping force can be obtained, and the flow path area of the back pressure introducing orifice 32 can be set sufficiently large.

Although in the foregoing example the third embodiment is combined with the first embodiment, the third embodiment may be combined with the second embodiment shown in FIGS. 4 and 5.

Although in the foregoing first to third embodiments, a damping force generating mechanism having a back pressure chamber is provided for each of the extension and compression sides, the damping force generating mechanism may be provided for either one of the extension and compression sides. Although in the foregoing first to third embodiments the present invention is explained as being applied to a dual-tube shock absorber having the reservoir 4, the present invention is not limited thereto but may be applied to a single-tube shock absorber having a gas chamber formed in a cylinder by a free piston. Although the damping force generating mechanism is provided in the piston assembly in the foregoing embodiments, the present invention is not limited thereto. The damping force generating mechanism may be provided in any other part of the shock absorber where a flow of hydraulic fluid is induced by the piston rod stroke, for example, outside the cylinder. Further, the hydraulic fluid is not limited to hydraulic oil but may be a gas. In such a case, the reservoir 4, the base valve 10 and the free piston are unnecessary.

Although in the foregoing first to third embodiments the valve spring 31 is used to urge the relief valve in the valve closing direction by the spring force thereof, the valve spring 31 is not necessarily needed. The use of the valve spring 31, however, enables the relief valve to open even more stably.

The shock absorbers according to the foregoing embodiments are capable of obtaining desired damping force characteristics.

Although only some exemplary embodiments of this invention have been described in detail above, those skilled in the art will readily appreciate that many modifications are possible in the exemplary embodiments without materially departing from the novel teaching and advantages of this invention. Accordingly, all such modifications are intended to be included within the scope of this invention.

The present application claims priority under 35 U.S.C. section 119 to Japanese Patent Application No. 2010-019557 filed on Jan. 29, 2010.

The entire disclosure of Japanese Patent Application No. 2010-019557 filed on Jan. 29, 2010 including specification, claims, drawings and summary is incorporated herein by reference in its entirety.

What is claimed is:

1. A shock absorber comprising:
a cylinder having a hydraulic fluid sealed therein; a piston slidably fitted in the cylinder;
a piston rod connected to the piston and extending to an outside of the cylinder;
a relief valve controlling a flow of the hydraulic fluid from an upstream chamber toward a downstream chamber induced by sliding movement of the piston in one direction;
a back pressure chamber applying a pressure therein to the relief valve in a direction for closing the relief valve;
a back pressure introducing orifice introducing the hydraulic fluid from the upstream chamber into the back pressure chamber;
a damping valve caused to open by the pressure in the back pressure chamber to generate a damping force against the flow of the hydraulic fluid toward the downstream chamber; and
a downstream orifice communicating between the back pressure chamber and the downstream chamber;
the back pressure introducing orifice having a flow path area that is constant or decreases according as a degree of opening of the relief valve increases.

2. The shock absorber of claim 1, wherein the flow path area of the back pressure introducing orifice and that of the downstream orifice are set so that, after the relief valve has opened as a result of an increase in a piston speed, the relief valve is kept open at piston speeds not lower than the piston speed at which the relief valve opens.

3. The shock absorber of claim 1, wherein the flow path area of the back pressure introducing orifice is set so that, after the damping valve has opened as a result of an increase in a piston speed, the relief valve is kept open at piston speeds not lower than the piston speed at which the damping valve opens by a pressure balance between an upstream side of the relief valve and the back pressure chamber.

4. The shock absorber of claim 1, further comprising a check valve allowing only a flow of the hydraulic fluid through the back pressure introducing orifice toward the back pressure chamber.

5. The shock absorber of claim 2, further comprising a check valve allowing only a flow of the hydraulic fluid through the back pressure introducing orifice toward the back pressure chamber.

6. The shock absorber of claim 3, further comprising a check valve allowing only a flow of the hydraulic fluid through the back pressure introducing orifice toward the back pressure chamber.

7. The shock absorber of claim 1, further comprising a back pressure check valve allowing a flow of the hydraulic fluid from the downstream chamber toward the back pressure chamber and introducing the hydraulic fluid into the back pressure chamber from the downstream chamber through a back pressure orifice when the piston slides in an other direction.

8. The shock absorber of claim 2, further comprising a back pressure check valve allowing a flow of the hydraulic fluid from the downstream chamber toward the back pressure chamber and introducing the hydraulic fluid into the back pressure chamber from the downstream chamber through a back pressure orifice when the piston slides in an other direction.

9. The shock absorber of claim 3, further comprising a back pressure check valve allowing a flow of the hydraulic fluid from the downstream chamber toward the back pressure chamber and introducing the hydraulic fluid into the back pressure chamber from the downstream chamber through a back pressure orifice when the piston slides in an other direction.

10. The shock absorber of claim 4, further comprising a back pressure check valve allowing a flow of the hydraulic fluid from the downstream chamber toward the back pressure chamber and introducing the hydraulic fluid into the back pressure chamber from the downstream chamber through a back pressure orifice when the piston slides in an other direction.

11. The shock absorber of claim 7, wherein the flow path area of the back pressure introducing orifice is larger than that of the downstream orifice but smaller than a sum total of the flow path areas of the downstream orifice and the back pressure orifice.

12. The shock absorber of claim 8, wherein the flow path area of the back pressure introducing orifice is larger than that of the downstream orifice but smaller than a sum total of the flow path areas of the downstream orifice and the back pressure orifice.

13. The shock absorber of claim 9, wherein the flow path area of the back pressure introducing orifice is larger than that of the downstream orifice but smaller than a sum total of the flow path areas of the downstream orifice and the back pressure orifice.

14. The shock absorber of claim 10, wherein the flow path area of the back pressure introducing orifice is larger than that of the downstream orifice but smaller than a sum total of the flow path areas of the downstream orifice and the back pressure orifice.

15. The shock absorber of claim 1, further comprising an urging member urging the relief valve in the direction for closing the relief valve.

16. The shock absorber of claim 1, further comprising a valve member attached to an end of the piston, the valve member having a guide portion extending along the piston rod;
an inner peripheral edge of the relief valve being movable along an outer peripheral surface of the guide portion of the valve member;
the back pressure introducing orifice being formed between the inner peripheral edge of the relief valve and the guide portion of the valve member.

17. The shock absorber of claim 16, wherein the guide portion of the valve member has a tapered portion formed on an outer peripheral surface of a distal end thereof that faces the inner peripheral edge of the relief valve, so that, when the relief valve opens, the flow path area of the back pressure introducing orifice decreases according as the degree of opening of the relief valve increases.
